(19) United States
(12) Patent Application Publication
(10) Pub. No.: US 2013/0044345 A1
(43) Pub. Date: Feb. 21, 2013

(54) CONTROL APPARATUS, CONTROL METHOD, AND COMPUTER READABLE STORAGE MEDIUM

(71) Applicant: Shigeto Sakai, Tokyo (JP)

(72) Inventor: Shigeto Sakai, Tokyo (JP)

(73) Assignee: CANON KABUSHIKI KAISHA, Tokyo (JP)

(21) Appl. No.: 13/557,636

(22) Filed: Jul. 25, 2012

(30) Foreign Application Priority Data
Aug. 19, 2011 (JP) 2011-179911

(51) Int. Cl. G06K 15/02

(52) U.S. Cl. 358/1.14

(57) ABSTRACT

A control apparatus controls a processing apparatus that executes predetermined processing. The control apparatus includes a determination unit that determines whether when executing the predetermined processing, the processing apparatus is in a state in which the processing apparatus has been powered on again after power supplied to the processing apparatus has been stopped, an input unit that, when the determination unit has determined that the processing apparatus has been powered on again, performs notification to cause a user of the processing apparatus to input authentication information to authenticate the user and inputs the authentication information in accordance with a user instruction based on the notification, and a permission unit that permits execution of the predetermined processing by the processing apparatus in accordance with the authentication information input by the input unit.

### BACKGROUND OF THE INVENTION

1. Field of the Invention

The present invention relates to a control apparatus for performing user authentication, a control method, and a computer readable storage medium.

2. Description of the Related Art

In recent years, a printing apparatus such as a printer, a multi-function peripheral, or a facsimile apparatus not only has basic functions such as copy, print, FAX, and scan but also is being equipped with a function of automatically acquiring and printing a print job entered from an external network (e.g., Web).

Using the function (referred to as a cloud printing function hereinafter) of automatically acquiring a print job entered from an external network and printing allows the user to print using a designated printing apparatus even from a remote site as long as the printing apparatus is connected to the network.

This function improves the convenience but simultaneously brings about a case in which, for example, a printing apparatus transferred to a third party receives a print job erroneously entered by the ex-user. In this case, the print job erroneously entered by the ex-user is executed under the current user.

As a result, the ex-user may unexpectedly allow the current user to see the print contents. On the other hand, unwanted printing is performed for the current user. To solve this problem, Japanese Patent Laid-Open No. 2004-249722 discloses a technique of displaying an authentication screen to cause the user to input authentication information and limiting use of a predetermined function until the contents input by the user satisfy authentication conditions.

When user authentication is required for a predetermined function, as in Japanese Patent Laid-Open No. 2004-249722, the user cannot use the function until he/she inputs correct authentication information. Hence, if user authentication is performed for a printing apparatus that has neither undergone transfer nor user change, the functions of the printing apparatus are unnecessarily limited.

### SUMMARY OF THE INVENTION

An aspect of the present invention provides a control apparatus capable of appropriately performing user authentication for a processing apparatus, a control method, and a computer readable storage medium.

From the above aspect, a control apparatus according to the present invention comprises the following units. That is, a determination unit configured to determine whether when executing the redetermined processing, the processing apparatus is in a state in which the processing apparatus has been powered on again after power supplied to the processing apparatus has been stopped; an input unit configured to, when the determination unit has determined that the processing apparatus has been powered on again, perform notification to cause a user of the processing apparatus to input authentication information to authenticate the user and input the authentication information in accordance with a user instruction based on the notification; and a permission unit configured to permit execution of the predetermined processing by the processing apparatus in accordance with the authentication information input by the input unit.

Further features of the present invention will become apparent from the following description of exemplary embodiments (with reference to the attached drawings).

### BRIEF DESCRIPTION OF THE DRAWINGS

FIG. 1 is a block diagram showing an example of the overall arrangement of a printing system according to an embodiment of the present invention;

FIG. 2 is a block diagram showing an example of the arrangement of a printing apparatus 10;

FIG. 3 is a flowchart showing an example of the procedure of processing of the printing apparatus 10;

FIGS. 4A and 4B are views showing examples of the display form of an operation panel 64 (display unit 64a);

FIG. 5 is a flowchart showing an example of the procedure of processing of the printing apparatus 10;

FIGS. 6A and 6B are flowcharts showing an example of the procedure of processing of the printing apparatus 10; and

FIG. 7 is a flowchart showing an example of the procedure of processing of the printing apparatus 10.

### DESCRIPTION OF THE EMBODIMENTS

An embodiment of the present invention will now be described in detail with reference to the accompanying drawings.

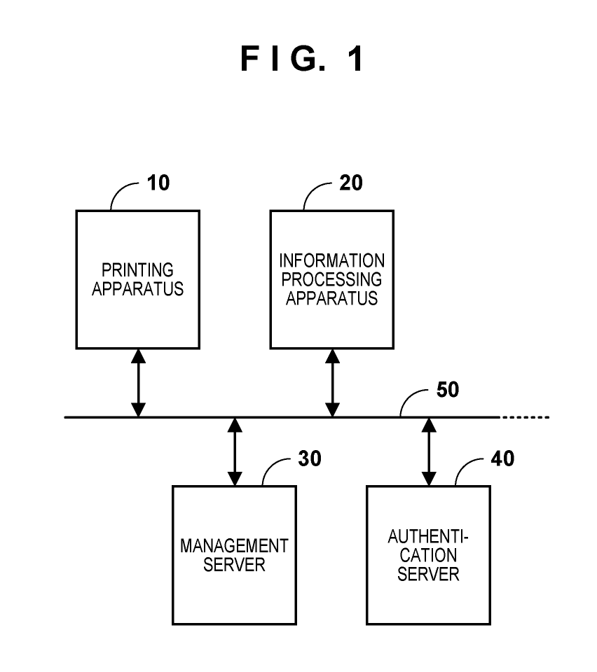

FIG. 1 is a block diagram showing an example of the overall arrangement of a printing system according to an embodiment of the present invention.

The printing system includes a printing apparatus 10, an information processing apparatus 20, a management server 30, and an authentication server 40. These apparatuses are connected via a network (external network) 50 such as a WAN (Wide Area Network) or a LAN (Local Area Network) so as to be communicable with each other.

The information processing apparatus 20 has a function of performing entry of a print job to the printing apparatus 10. The information processing apparatus 20 is implemented by, for example, a personal computer, a mobile phone (e.g., smartphone), or a PDA (Personal Display Assistant). The information processing apparatus 20 can be any apparatus that can cope with external network communication and has a function of requesting (entering) a print job via the external network.

The management server 30 manages print jobs. For example, the management server 30 manages a print job entered by the information processing apparatus 20.

The printing apparatus 10 acquires a print job from the management server 30 and prints on a printing medium such as a paper sheet (or fabric, plastic film, metal plate, glass, ceramic, resin, wood, leather, or the like) based on the print job. The printing apparatus 10 has a function (cloud printing function) of automatically acquiring and printing a print job entered from the external network 50. In this embodiment, user authentication is performed for the cloud printing function of the printing apparatus 10. Note that the printing apparatus 10 can be, for example, a single-function printer having only a printing function or a multi-function printer having a plurality of functions such as a printing function, a FAX function, and a scanner function. The printing apparatus 10 may be an apparatus for manufacturing, for example, a color filter, an electronic device, an optical device, or a microstructure by a predetermined printing method.

When cloud printing requested from the information processing apparatus 20 is to be performed, the authentication server 40 performs user authentication for the information processing apparatus 20. User authentication is performed to confirm whether the user who is going to use the cloud printing function is an authentic user to use the function. In this embodiment, a case will be explained in which authentication is performed by sending authentication information (e.g., identification code or biometric information) input by the user to the authentication server 40 and causing it to collate the authentication information.

A processing procedure when printing using the cloud printing function requested from the information processing apparatus 20 is performed under this printing system will be described.

The user enters a print job by an operation from the information processing apparatus 20. The print job is managed by the management server 30. The management server 30 sends the managed print job to the printing apparatus 10 in response to a query from the printing apparatus 10. The printing apparatus 10 receives the print job and prints based on it. The printing system shown in FIG. 1 thus automatically prints the print job entered from the external network 50. That is, cloud printing is performed.

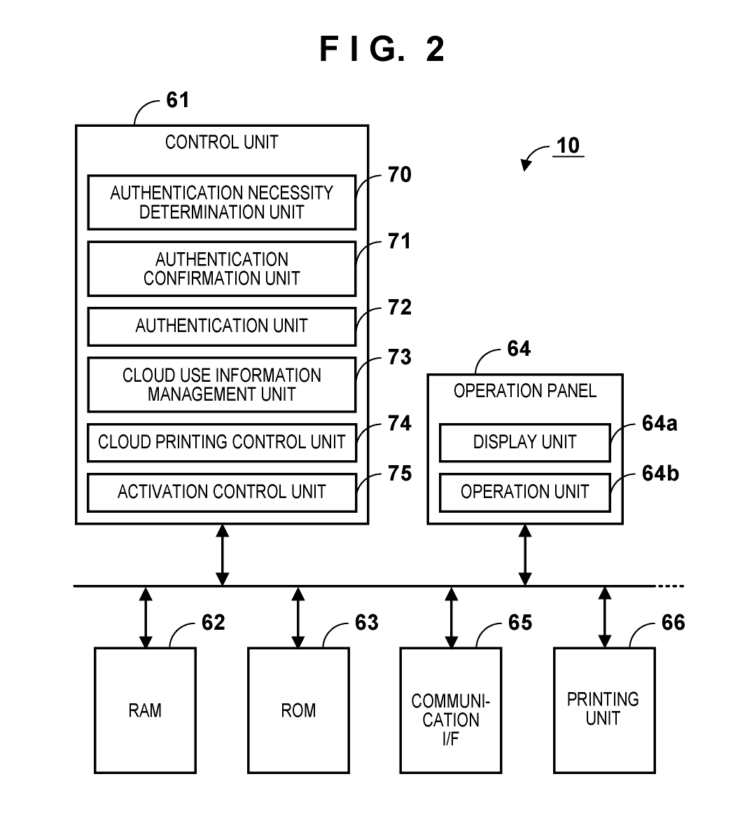

An example of the arrangement of the printing apparatus 10 shown in FIG. 1 will be described next with reference to FIG. 2.

The printing apparatus 10 includes, as its functional components, a control unit 61, a RAM 62, a ROM 63, an operation panel 64, a communication I/F 65, and a printing unit 66.

The control unit 61 is implemented by, for example, a CPU (Central Processing Unit) and generally controls the operation of the printing apparatus 10. More specifically, the control unit 61 performs various kinds of data processing, instruction operations, and the like in accordance with programs stored in the ROM 63 or the like.

The RAM (Random Access Memory: volatile memory) 62 is used by the control unit 61 as a work area to execute various kinds of programs. The RAM 62 stores, for example, information representing whether the cloud printing function is enabled and cloud authentication information. The ROM 63 (Read Only Memory: non-volatile memory) stores various kinds of control data, program instruction sequences to be executed by the control unit 61, and various kinds of control tables. Note that the ROM 63 is configured to be data-writable. The ROM 63 holds, for example, setting information of functions (e.g., main body setup) other than the cloud printing function of the printing apparatus 10.

The printing apparatus 10 includes a power plug (not shown). When the power plug is connected to the power supply, power is supplied to the printing apparatus 10 so that the printing apparatus 10 can be activated. In this embodiment, this state is called a primary power on state or hardware on state. When the user presses the power button of the printing apparatus 10 in the primary power on state, the printing apparatus is activated so that the functions of the printing apparatus become executable. This state is called a secondary power on state or software on state. Note that the printing apparatus 10 can determine the amount of power supplied to it and thus determine based on the supply amount whether the power plug is connected to the power supply.

The operation panel 64 functions as the user interface between the user and the printing apparatus 10, and includes a display unit 64a and an operation unit 64b. The display unit 64a is implemented by, for example, a liquid crystal display to display various kinds of information for the user. The operation unit 64b is implemented by, for example, buttons and a ten-key pad to input various kinds of user instructions into the apparatus. Note that the display unit 64a and the operation unit 64b may be integrally implemented as a touch panel.

The communication I/F (interface) 65 is a communication interface that connects communication between the printing apparatus 10 and the remaining apparatuses (information processing apparatus 20, management server 30, and authentication server 40) on the external network 50. The printing unit 66 prints on a printing medium based on a print job.

An example of the functional components implemented by the control unit 61 will be described here.

The control unit 61 implements, as its functional components, an authentication necessity determination unit 70, an authentication confirmation unit 71, an authentication unit 72, a cloud use information management unit 73, a cloud printing control unit 74, and an activation control unit 75. Each functional component is implemented by, for example, causing the CPU to read out a program stored in the ROM 63 or the like and execute it. Note that some or all of the functional components may be implemented by dedicated hardware, as a matter of course.

The authentication necessity determination unit 70 determines whether user authentication is necessary for using the cloud printing function at the time of activation of the printing apparatus 10 (at the time of software on: when the power button is pressed). Note that determining whether user authentication is necessary is done by referring to cloud authentication information managed by the cloud use information management unit 73 to be described later.

In this embodiment, the control unit 61 determines that user authentication is necessary when the printing apparatus 10 has changed from a state with the power plug being disconnected from the power supply to the hardware on state with the power plug being connected to the power supply and then to the software on state in accordance with power button pressing by the user.

When transferring the printing apparatus 10, the user often disconnects the power plug from the power supply. For this reason, performing user authentication in the hard on state, as described above, makes it possible to appropriately perform the user authentication when the new user uses the printing apparatus 10 for the first time.

In addition, as described above, user authentication is performed when the printing apparatus 10 is activated to the software on state. For a function of automatically receiving a print job without a user instruction, like the cloud printing function, the printing apparatus 10 is preferably always capable of receiving a print job when activated. Hence, the printing apparatus 10 can be activated in the state capable of receiving a print job by performing user authentication at the time of activation of the printing apparatus.

In the above description, user authentication is performed when the printing apparatus 10 has changed from the hardware on state to the software on state. In this embodiment, it is determined, only at the first software on time, that user authentication is necessary. That is, if the power button is pressed in the software on state to stop the printing apparatus 10 and then pressed in the hardware on state to set the apparatus in the software on state again, the printing apparatus 10 determines that user authentication is unnecessary and does not perform user authentication.

Hence, when execution of the cloud printing function is permitted by user authentication, and the printing apparatus 10 is then repetitively activated/stopped while keeping the power plug connected to the power supply, the user can use the cloud printing function without inputting authentication information every time the apparatus is activated.

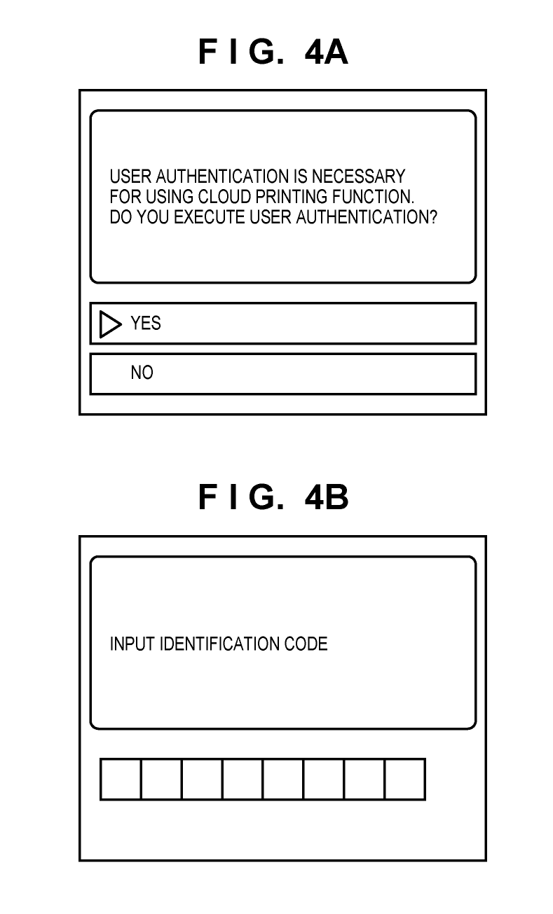

When the authentication necessity determination unit 70 has determined that user authentication is necessary, the authentication confirmation unit 71 confirms the user whether to perform user authentication. The display unit 64a displays the screen shown in FIG. 4A, and details will be described later.

The authentication unit 72 performs user authentication for the cloud printing function, and determines whether to permit execution of the cloud printing function. In this embodiment, authentication information (e.g., identification code or biometric information) is input in accordance with a user operation on the operation unit 64b, as described above. The authentication unit 72 sends the input authentication information to the authentication server 40 and receives the collation result from the authentication server 40, thereby performing user authentication. This allows to determine whether to permit execution of the cloud printing function. The user authentication may be performed by another method, as a matter of course. For example, the user authentication may be performed by the printing apparatus alone.

When user authentication has been performed to use cloud printing, the cloud use information management unit 73 manages information (i.e., cloud authentication information) representing that the authentication has succeeded. If use of the cloud printing function is permitted as the result of user authentication by the above-described authentication unit 72, the cloud use information management unit 73 registers cloud authentication information. The above-described authentication necessity determination unit 70 determines, by referring to the cloud authentication information, whether user authentication is necessary. Note that the cloud authentication information is set to “enable” when user authentication by the authentication unit 72 has succeeded, or “disable” otherwise. In this embodiment, when user authentication has been done, the cloud use information management unit 73 sets “enable”. When the power plug of the printing apparatus 10 is disconnected from the power supply or connected to the power supply, the cloud use information management unit 73 sets “disable”.

For example, a flag representing that user authentication is necessary may be set in a non-volatile memory such as the ROM 63, and the value of the flag may be used as the cloud authentication information. More specifically, when the power plug is connected to the power supply to set the apparatus in the hardware on state or when the power plug is disconnected from the power supply, the control unit 61 inputs “0” to the flag. When the flag is “0”, the cloud printing function is disabled, and user authentication is necessary. When the authentication unit 72 has performed user authentication, the control unit 61 changes the value of the flag to “1”. When the flag is “1”, the cloud printing function is enabled, and user authentication is unnecessary.

When the printing apparatus 10 is set in the software on state by activation control of the activation control unit 75 to be described later, the authentication necessity determination unit 70 refers to the value of the flag. The flag is “0” when the printing apparatus 10 changes to the software on state for the first time after the hardware on state. Therefore it is determined that user authentication is necessary. The flag changes to “1” when user authentication has succeeded. Therefore it is determined, at the next software on time, that user authentication is unnecessary. When the power plug is disconnected from the power supply, and the printing apparatus 10 changes to the hardware on state again, the flag is set to “0” again. Hence, when activating the printing apparatus, it is determined again that user authentication is necessary.

Note that the cloud authentication information need not always represent both the enable state and the disable state of the cloud printing function, like the above-described flag. It may be information representing only that the cloud printing function is enabled. In this case, when the cloud printing function is permitted by the authentication unit 72, the cloud use information management unit 73 stores the cloud authentication information in a memory such as the RAM 62. When the cloud printing function is not permitted, the cloud authentication information is not stored in the memory. The authentication necessity determination unit 70 determines, based on whether the cloud authentication information is stored in the memory, whether the cloud printing function is permitted.

The cloud printing control unit 74 controls execution of various kinds of processing concerning cloud printing. Details of the processing of the cloud printing control unit 74 will be described later. The activation control unit 75 controls activation of various kinds of functions of the printing apparatus 10 upon power on (i.e., pressing of the power button).

An example of the arrangement of the printing apparatus 10 has been described above. Note that the above-described information processing apparatus 20, management server 30, and authentication server 40 incorporate the same computer configuration as that of the printing apparatus 10. The computer includes a main control means such as a CPU, and storage means such as a ROM, a RAM, and an HDD. The computer also includes input/output means such as a keyboard, a mouse, a display, or a touch panel, and a communication means such as a network card. Note that these constituent means are connected by a bus or the like and controlled by causing the main control means to execute programs stored in the storage means.

As described above, in this embodiment, user authentication for the cloud printing function of the printing apparatus 10 is performed by the authentication necessity determination unit 70 and the authentication unit 72. In this embodiment, however, even when the cloud authentication information managed by the cloud use information management unit 73 does not represent success of user authentication, the printing apparatus 10 is activated so as to make its functions other than the cloud printing function executable. That is, if execution of the cloud printing function is not permitted, the printing apparatus 10 is activated while permitting the functions other than the cloud printing function without permitting the cloud printing function.

This allows the user to execute the functions other than the cloud printing function when user authentication for the cloud printing function has not succeeded or no user authentication has been done.

Note that the authentication information input by the user may be stored in a volatile memory such as the RAM 62. In this case, the above-described authentication information is erased at the time of power stop. It is therefore possible to prevent the printing apparatus from being transferred to a new user while keeping the printing apparatus storing the authentication information registered by the previous user. When the authentication information is stored in a non-volatile memory such as the ROM 63, it may be deleted from the memory at the time of power stop together with the cloud authentication information to be described later.

As described above, the authentication information is erased at the time of power stop. However, pieces of information such as print settings at the time of printing or default set values in various kinds of functions are stored in the non-volatile ROM 63 to prevent erase even at the time of power stop.

This allows the user to use the above-described information stored in the non-volatile memory when the printing apparatus is powered on again even after the power stop. Note that the contents of information stored in the non-volatile memory and kept stored even at the time of power stop can be configured to be selectable as needed. This information is preferably, for example, information that is usable when the printing apparatus is powered on again and does not pose any problem even when another user knows it upon transferring the printing apparatus.

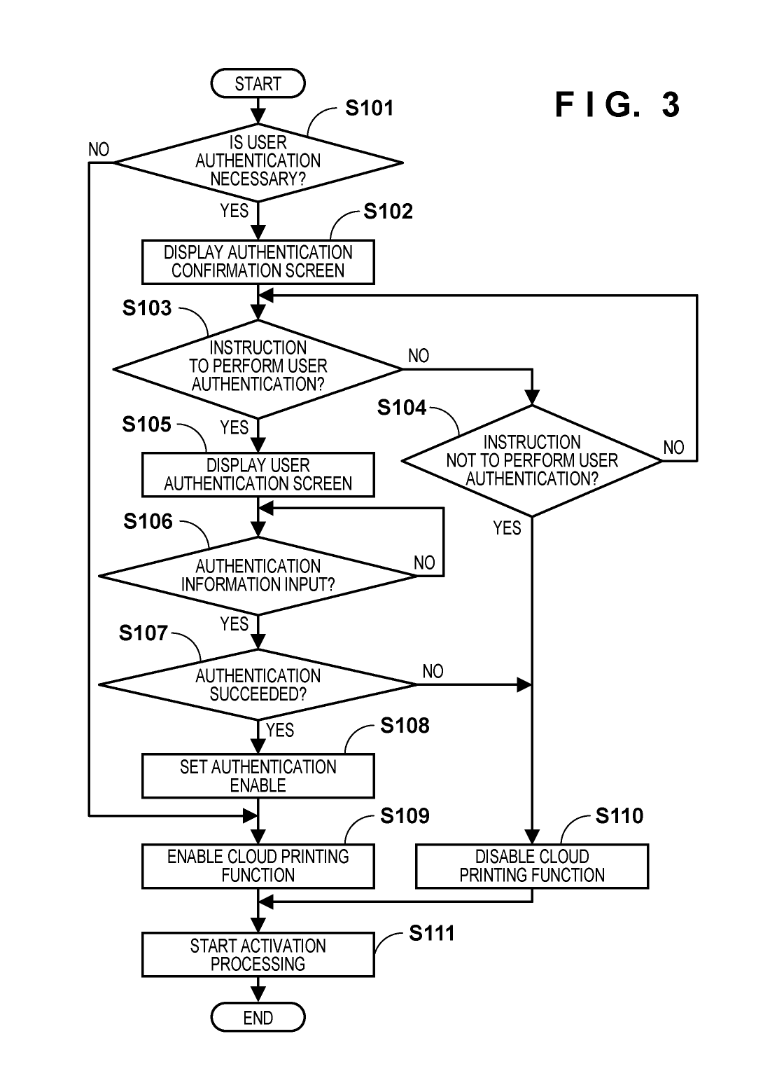

An example of the procedure of processing of the printing apparatus 10 at the time of activation will be explained next with reference to FIG. 3.

This processing starts when the user presses the power button of the printing apparatus 10 in the hardware on state. When the processing starts, the printing apparatus 10 causes the authentication necessity determination unit 70 to determine whether user authentication is necessary. This determination is done by, for example, referring to the cloud authentication information managed by the cloud use information management unit 73. If user authentication is unnecessary (NO in step S101), the printing apparatus 10 is activated in a state in which the cloud printing operation is enabled under the control of the activation control unit 75 (steps s109 and S111).

On the other hand, if user authentication is necessary (YES in step S101), the printing apparatus 10 causes the authentication confirmation unit 71 to display an authentication confirmation screen on the display unit 64a (step S102). The authentication confirmation screen is used to confirm whether to perform user authentication when using the cloud printing function, and has a screen layout shown in, for example, FIG. 4A.

When the user designates “NO” on the authentication confirmation screen, that is, the user instructs not to perform user authentication (NO in step S103, and then, YES in step S104), the printing apparatus 10 is activated while disabling the cloud printing function under the control of the activation control unit 75 (steps s110 and 5111). When the printing apparatus 10 is activated in this way, the functions other than the cloud printing function of the printing apparatus 10 are usable, and the cloud printing function is unusable.

When the user designates “YES” on the authentication confirmation screen, that is, the user instructs to perform user authentication (YES in step S103), the printing apparatus 10 causes the authentication unit 72 to display a user authentication screen on the display unit 64a (step S105). The authentication screen is used to input authentication information to use the cloud printing function, and has a screen layout shown in, for example, FIG. 4B. The user inputs authentication information via, for example, the operation unit 64b.

If the user has input authentication information via the operation unit 64b (YES in step S106), the printing apparatus 10 causes the authentication unit 72 to perform authentication processing based on the authentication information.

If the authentication has failed as the result of authentication (NO in step S107), the printing apparatus 10 is activated while disabling the cloud printing function under the control of the activation control unit 75 (steps s110 and 5111). Note that if the authentication has failed, the process may return to step S105 to display the user authentication screen again. In this case, user authentication may be repeated, for example, an arbitrary number of times.

On the other hand, if the authentication has succeeded (YES in step S107), the printing apparatus 10 causes the cloud use information management unit 73 to set cloud authentication information to “enable” (step S108) and is then activated while enabling the cloud printing function (steps s109 and 5111). Note that in this embodiment, if the cloud authentication information is set to “enable”, user authentication is determined to be unnecessary in step S101. The cloud authentication information is changed from “enable” to “disable” when the power plug of the printing apparatus 10 is disconnected from the power supply. For this reason, the user need not perform user authentication in every cloud printing as long as the printing apparatus 10 keeps the hardware on state without disconnecting the power plug from the power supply.

Note that as the internal processing method of obviating the necessity of user authentication in the processing of step S101, the cloud use information management unit 73 may uniformly return authentication enable to obviate the necessity of user authentication.

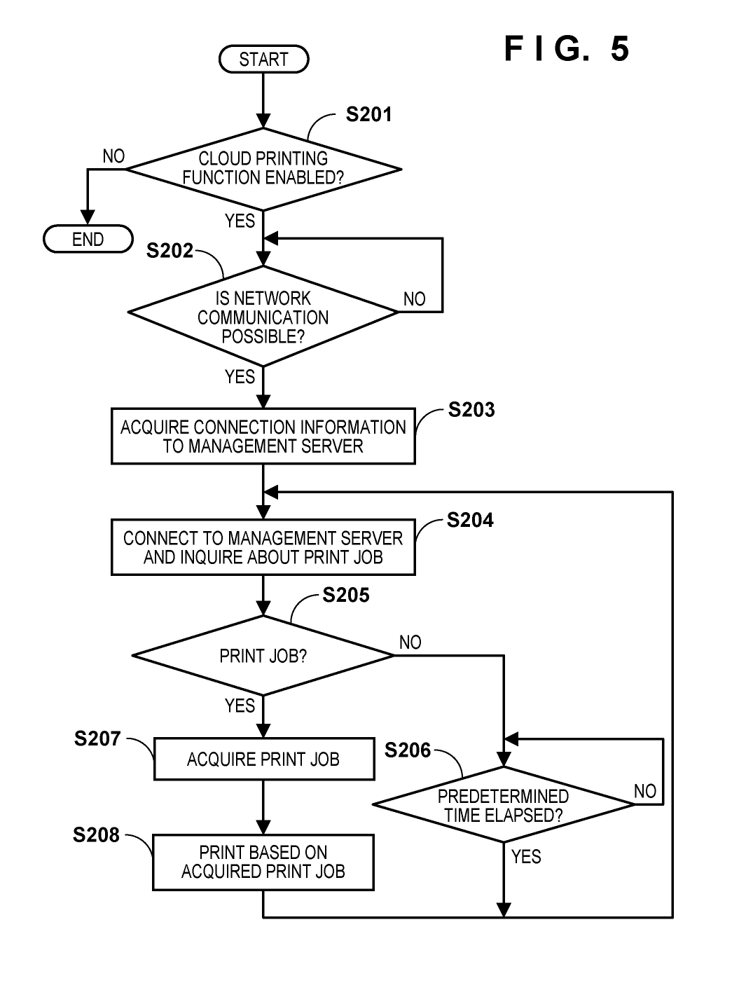

An example of the procedure of processing of the printing apparatus 10 after activation (i.e., cloud printing control processing) will be explained next with reference to FIG. 5. This processing is performed after the activation processing described with reference to FIG. 3.

The printing apparatus 10 causes the cloud printing control unit 74 to determine whether the cloud printing function is enabled. Once the cloud printing function is determined to be disabled (NO in step S201), the printing apparatus 10 ends the cloud printing control processing.

On the other hand, if the cloud printing function is enabled (YES in step S201), the printing apparatus 10 causes the cloud printing control unit 74 to determine whether communication using the communication I/F via the external network 50 is possible. That is, the cloud printing control unit 74 determines whether communication with the external network 50 is possible.

If communication is determined to be impossible (NO in step S202), the printing apparatus 10 waits until the communication becomes possible (NO in step S202). At this time, the printing apparatus may notify the user of it by, for example, displaying information representing that the communication is impossible on the display unit 64a.

On the other hand, if communication with the external network 50 is possible (YES in step S202), the printing apparatus 10 causes the cloud printing control unit 74 to acquire connection information to the management server 30 (step S203). Note that the connection information is stored in the ROM 63 or the like in advance.

After acquiring the connection information to the management server 30, the printing apparatus 10 causes the cloud printing control unit 74 to connect to the management server 30 using the connection information and inquire whether a print job exists (step S204). If no print job exists as the result of query (NO in step S205), the printing apparatus 10 waits for a predetermined time (step S206) and returns to the processing of step S204 again to send the print job query to the management server 30.

If a print job exists as the result of the processing of step S205 (YES in step S205), the printing apparatus 10 causes the cloud printing control unit 74 to acquire the print job (step S207). If a print job exists, the management server 30 sends, for example, a URL representing the storage location of the print job to the printing apparatus 10. Accordingly, the printing apparatus 10 accesses the URL to acquire the print job. Upon acquiring the print job, the printing apparatus 10 causes the printing unit 66 to execute printing based on the print job (step S208), and returns to the processing of step S204 again.

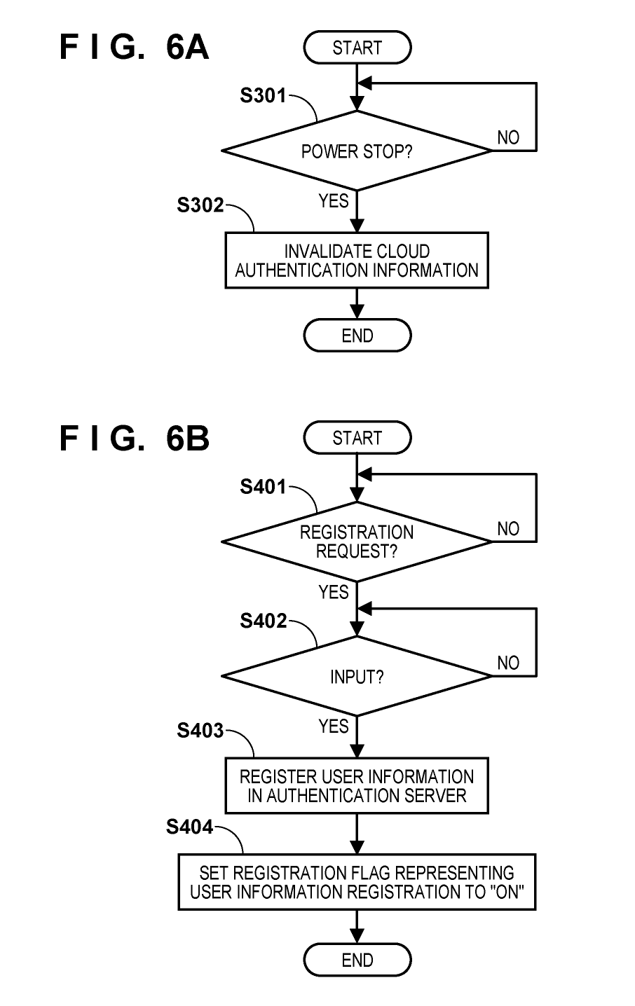

Processing of invalidating cloud authentication information managed by the cloud use information management unit 73 will be described next with reference to FIG. 6A.

This processing starts when the power is stopped by disconnecting the power plug of the printing apparatus 10 (YES in step S301). For example, the processing starts when the power button provided on the main body of the printing apparatus 10 is pressed. Note that even when the power plug is disconnected, the control unit 61 can execute the processing shown in FIG. 6A using, for example, a battery in the printing apparatus.

When the power is stopped, the printing apparatus 10 causes the cloud use information management unit 73 to invalidate cloud authentication information (step S302) and, for example, stops the power of the apparatus, thereby ending the processing.

Note that cloud authentication information invalidation may be performed by another processing or at another timing. Several examples of the method of invalidating the cloud authentication information will be explained here.

For example, when the cloud use information management unit 73 holds the cloud authentication information using a RAM (i.e., volatile memory) or the like, the cloud authentication information is necessarily erased by power stop and thus invalidated. For example, when the cloud authentication information is managed in a non-volatile memory (e.g., ROM 63) other than a RAM, the cloud authentication information may be invalidated at the time of power stop. Alternatively, the cloud authentication information may be invalidated upon repowering-on after the power stop.

Note that cloud authentication information invalidation need not always be performed when such physical power stop has been done. That is, the printing apparatus 10 may need only be configured to require user authentication when its power has been stopped. For example, if the printing apparatus includes a battery or the like, the cloud authentication information may be invalidated by determining, upon unplugging to stop the supplied power, that the power has been stopped.

As described above, according to this embodiment, it is confirmed whether to perform user authentication at the time of activation (i.e., at the time of software on) of the printing apparatus 10 upon powering-on. Even when the user authentication has not succeeded, the functions other than the cloud printing function are usable without limitations, and only use of the cloud printing function is limited by user authentication.

Hence, the user can execute the functions other than the cloud printing function even when user authentication for the cloud printing function has failed, or the user authentication has not been performed at all.

In this embodiment, user authentication is performed when activating the printing apparatus. That is, even when the user does not perform a special operation to enable the cloud printing function, the cloud printing function can properly be enabled at the time of activation. This makes it possible to prevent the user from being unable to receive a print job by the cloud printing function without knowing that the cloud printing function is disabled.

When authentication has succeeded, information representing that the user has been authenticated is held until power stop. Additionally, as described above, whether to perform user authentication is confirmed at the first activation (i.e., software on) time of the printing apparatus upon power button pressing. Hence, once authenticated, the user can use the cloud printing function without user authentication even after the printing apparatus has been stopped by pressing the power button until the power stop. That is, once authenticated, the user is not required to perform user authentication every time he/she executes cloud printing, resulting in improved operability.

If user authentication has not been performed, or user authentication has failed, the printing apparatus is activated while disabling only the cloud printing function. Hence, the conventional problem that the printing apparatus cannot be activated can be avoided.

When transferring the printing apparatus to a third party, the power is stopped at a high probability. Hence, use of the cloud printing can be disabled after the power stop. For this reason, when such transfer has been done, use of the cloud printing by the third party can be limited. It is also possible to prevent the printing apparatus after transfer from printing a printed matter designated by the user of the printing apparatus before transfer and thus improve the security.

At this time, information that can be held in the printing apparatus at the time of transfer to the third party, except information concerning cloud printing, is kept even after the power stop. Hence, the information other than the information concerning cloud printing can continuously be used even after the power stop.

As described above, according to this embodiment, it is possible to improve the operability and security when performing printing using the cloud printing function.

A case will be described next in which user information registration in the authentication server 40 is necessary when using the above-described cloud printing function.

An example of the procedure of user information registration processing will be described with reference to FIG. 6B. This processing is performed after the activation processing described with reference to FIG. 3.

This processing starts when the user has input a user information registration request via the operation panel 64 (YES in step S401). The printing apparatus 10 waits until user information is input by the user when the processing starts (NO in step S402).

When the user has input user information via the operation panel 64 (YES in step S402), the printing apparatus 10 causes the cloud printing control unit 74 to send the input user information to the authentication server 40. The user information is thus registered in the authentication server 40 (step S403).

After user information registration in the authentication server 40, the printing apparatus 10 causes the cloud printing control unit 74 to hold, in the RAM 62 or the like, information (e.g., registration flag “on”) representing that the registration in the server has been done (step S404). After that, the printing apparatus 10 ends the processing.

Note that the user information registration destination need not always be the authentication server 40. The user information may be held in, for example, the RAM 62 (i.e., non-volatile memory) provided in the printing apparatus 10. The user information may be authentication information (e.g., identification code or biometric information).

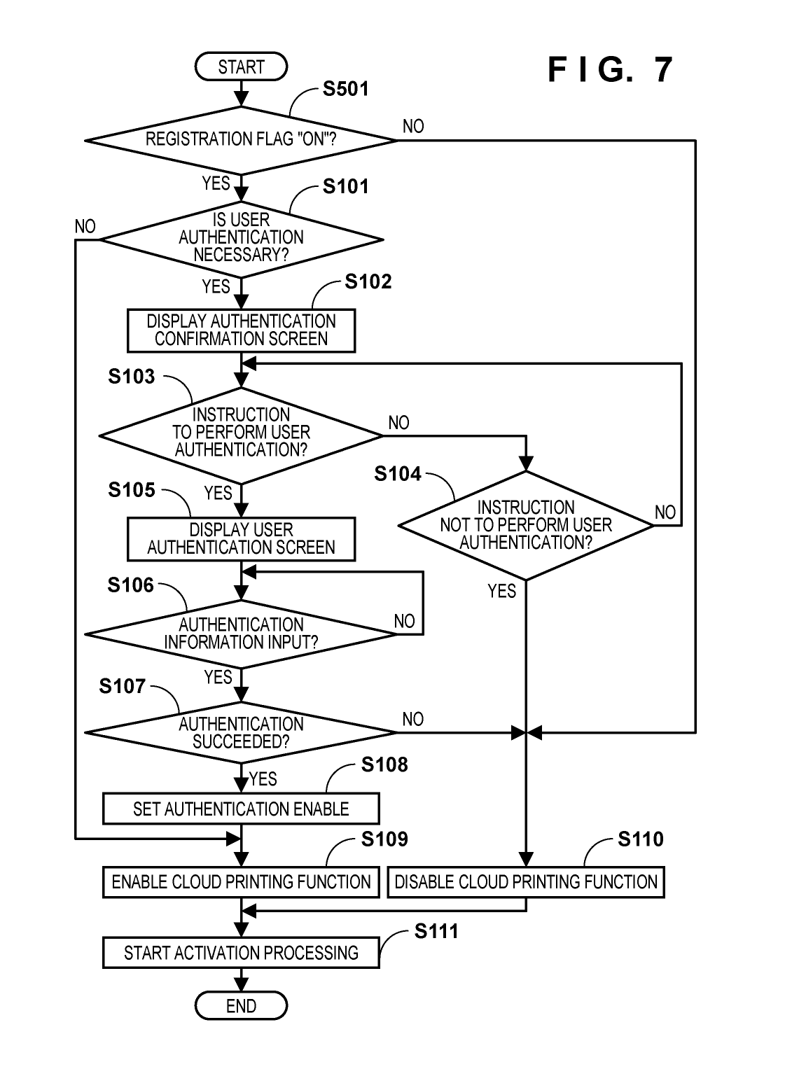

If the apparatus is configured to need user information registration in the authentication server 40, the procedure of processing of the printing apparatus 10 at the time of activation is represented by the operation shown in FIG. 7. Unlike FIG. 3, processing of step S501 is executed prior to the whole processing.

More specifically, when this processing starts, the printing apparatus 10 determines whether the registration flag is on. Once the registration flag is determined to be on (YES in step S501), the printing apparatus 10 executes the processing from step S101, as in FIG. 3. On the other hand, if the registration flag is off (NO in step S501), user information registration in the authentication server 40 has not been done yet. Hence, the printing apparatus 10 is activated while disabling the cloud printing function without displaying the authentication confirmation screen or the like (steps s110 and S111).

As described above, according to the processing shown in FIG. 7, user information registration in the authentication server 40 is necessary when using the cloud printing function. Hence, if the registration has not been done yet, display of the authentication confirmation screen necessary for using cloud printing can be prohibited.

That is, in the processing of FIG. 3, the authentication confirmation screen is always displayed if user authentication has not been performed yet. In the processing of FIG. 7, however, if cloud printing is unusable or is not used by the user, display of the authentication confirmation screen of cloud printing can be prohibited.

Note that in the above-described embodiment, an example has been explained in which the printing apparatus performs user authentication to execute the cloud printing function. However, the present invention is not limited to the cloud printing function and is also applicable when the printing apparatus receives a print job from various kinds of apparatuses such as a host computer and performs printing.

In the above-described embodiment, the control unit 61 in the printing apparatus performs user authentication for the cloud printing function, and the printing apparatus is activated in accordance with the result. However, the present invention is not limited to this, and an apparatus such as a host computer independent of the printing apparatus (i.e., control apparatus) may be configured to perform user authentication or activate the printing apparatus.

In addition, the above-described processing may be applied to authentication of a user who executes not only print processing but also various kinds of functions such as a function of displaying an image and a function of browsing a file with security settings. In this case, the processing is applicable not only to the printing apparatus but also various kinds of apparatuses such as a PC, a mobile phone, and a camera (i.e., processing apparatuses) at the time of user authentication.

The contents described in the above embodiment can also be implemented by executing the following processing. That is, software (program) that implements the functions of the above-described embodiment is supplied to the system or apparatus via a network or various kinds of storage media, and the computer (or CPU or MPU) of the system or apparatus reads out and executes the program. The above-described processing need not always be executed by only one processor and may be executed by a plurality of processors.

An example of the representative embodiment of the present invention has been described above. However, the present invention is not limited to the embodiment described and illustrated above, and changes and modifications can be made within the spirit and scope of the invention.

According to the present invention, since user authentication is executed in accordance with power stop of the processing apparatus, user authentication for the processing apparatus can be performed appropriately.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-179911 filed on Aug. 19, 2011, which is hereby incorporated by reference herein in its entirety.

What is claimed is:

1. A control apparatus for controlling a processing apparatus that executes predetermined processing, comprising:
a determination unit configured to determine whether when executing the predetermined processing, the processing apparatus is in a state in which the processing apparatus has been powered on again after power supplied to the processing apparatus has been stopped;
an input unit configured to, when said determination unit has determined that the processing apparatus has been powered on again, perform notification to cause a user of the processing apparatus to input authentication information to authenticate the user and input the authentication information in accordance with a user instruction based on the notification; and
a permission unit configured to permit execution of the predetermined processing by the processing apparatus in accordance with the authentication information input by said input unit.

2. The apparatus according to claim 1, further comprising an activation control unit configured to activate the processing apparatus when power is being supplied to the processing apparatus,
wherein said input unit performs the notification and inputs the authentication information in accordance with the user instruction based on the notification when the processing apparatus is activated by said activation unit.

3. The apparatus according to claim 2, wherein if said permission unit permits execution of the predetermined processing by the processing apparatus, and power supply to the processing apparatus is kept, the processing apparatus is controlled to keep a state in which execution of the predetermined processing is permitted independently of input of the authentication information by said input unit at a time of reactivation of the processing apparatus.

4. The apparatus according to claim 2, wherein even if said permission unit does not permit execution of the predetermined processing, said activation control unit activates the processing apparatus so that the processing apparatus can execute processing different from the predetermined processing.

5. The apparatus according to claim 1, wherein
said permission unit stores information representing that execution of the predetermined processing is permitted in a volatile memory included in the processing apparatus, and
said determination unit determines, based on whether the information is stored in the memory, whether the processing apparatus has been powered on again.

6. A control method of a control apparatus for controlling a processing apparatus that executes predetermined processing, comprising:
a determination step of determining whether when executing the predetermined processing, the processing apparatus is in a state in which the processing apparatus has been powered on again after power supplied to the processing apparatus has been stopped;
an input step of, when it is determined in the determination step that the processing apparatus has been powered on again, performing notification to cause a user of the processing apparatus to input authentication information to authenticate the user and inputting the authentication information in accordance with a user instruction based on the notification; and
a permission step of permitting execution of the predetermined processing by the processing apparatus in accordance with the authentication information input in the input step.

7. A non-transitory computer readable storage medium storing a program that causes a computer to execute a control method of claim 6.
